(19) United States
(12) Patent Application Publication
(10) Pub. No.: US 2018/0181383 A1
(43) Pub. Date: Jun. 28, 2018

(54) CONTROLLING APPLICATION DEPLOYMENT BASED ON LIFECYCLE STAGE

(71) Applicant: ENTIT Software LLC, Sunnyvale, CA (US)

(72) Inventor: Kishore Jagannath, Bangalore (IN)

(21) Appl. No.: 15/580,444

(22) PCT Filed: Mar. 11, 2016
(86) PCT No.: PCT/US2016/021908

§ 371 Date: Dec. 7, 2017

(30) Foreign Application Priority Data
Jun. 24, 2015 (IN) 3171/CHE/2015

(51) Int. Cl. G06F 8/61; G06F 9/455; G06F 9/50

(52) U.S. Cl. CPC G06F 8/61; G06F 9/45558; G06F 2009/45583; G06F 2009/4557; G06F 2009/45595; G06F 9/5077

(57) ABSTRACT

A method includes deploying an application on a target virtual resource environment that includes at least one virtual machine for an associated lifecycle stage of the application. Deploying the application includes selecting a given physical resource environment to support the target virtual resource environment from a plurality of physical resource environments based at least in part on the lifecycle stage and a predefined physical resource environment-to-lifecycle stage mapping.

### BACKGROUND

A cloud service generally refers to a service that allows end recipient computer systems (thin clients, portable computers, smartphones, desktop computers and so forth) to access a pool of hosted computing and/or storage resources (i.e., the cloud resources) and networks over a network (the Internet, for example).

Enterprises are ever-increasingly using cloud services to develop and deploy applications. Enterprises, in general, typically want to quickly move a set of innovative features to production to gain a competitive edge in the market place.

### BRIEF DESCRIPTION OF THE DRAWING

FIG. 1 is a schematic diagram of a networked computer system according an example implementation.

FIGS. 2 and 5 are flow diagrams depicting techniques to deploy an application according to example implementations.

FIG. 3 is a schematic diagram illustrating a model for an application according to an example implementation.

FIG. 4 is an illustration of a physical resource environment-to-lifecycle stage mapping according to an example implementation.

FIG. 6 is a schematic diagram of the cloud service manager of FIG. 1 according to an example implementation.

### DETAILED DESCRIPTION

An enterprise may use development operation products (called “Devops products” herein) for purposes of quickly developing and deploying their applications into cloud environments. In this context, “deploying” an application to a cloud environment generally refers to installing the application on one or multiple components of the cloud environment, including performing activities to make the application available to use via the cloud environment, such as provisioning virtual and physical resources of the cloud environment for the application; communicating files and data to the cloud environment; and so forth.

In general, a Devops product may enhance the joint cooperation and participation of teams that may be assigned tasks relating to the different lifecycle stages of the application. The lifecycle stages may include a development stage in which the machine executable instructions, or “program code,” for the application may be written; a testing stage in which components of the application may be brought together and checked for errors, bugs and interoperability; a staging stage in which production deployment may be tested; and a production stage in which the application may be placed into production. The application may be deployed in more than one lifecycle stage at the same time. For example, developers and testers may be developing code and testing code implementations for the development and testing lifecycle stages at the same time that a version of the application may be in the process of being staged and evaluated in the staging lifecycle stage.

Over the course of its development, the business enterprise may deploy the application onto different virtual resource environments for the different lifecycle stages of the application. The “virtual resource environment” refers to the virtual resources that are available to the application. A given virtual resource environment may be defined by such factors as a number of virtual machines and the number of compute and memory shares of the corresponding resource pool, which is allocated to the virtual machines.

A Devops product may be used by application architects and developers of the business enterprise to model the overall application deployment process; and a resource administrator may use a Devops product to configure the virtual resource environments onto which the application may be deployed for the different lifecycle stages. The parameters of the virtual resource environments may vary, according to the demands of the lifecycle stage. As an example, for the production lifecycle stage, the application may be deployed on a virtual environment that may contain one hundred virtual machines, whereas for the testing stage, the application may be deployed on a virtual resource environment that may contain twenty virtual machines. Moreover, the virtual resource environment may have more allocated compute and memory resource pool shares for the production lifecycle stage than for the testing lifecycle stage.

The virtual resource environment may be based on a sharing model in which underlying physical resources support the virtual resources of the virtual resource environment. The virtual resources are abstractions of actual devices, whereas the “physical resources” refer to the actual, real devices that support the virtual resources. As examples, physical resources may include: central processing unit (CPU) cores; random access memories (RAMs); RAM partitions; non-volatile memories; non-volatile memory partitions; solid state drives (SSDs); magnetic storage-based disk drives; storage network or arrays; servers; server groups; clients; terminals; and so forth. The physical resources that support the virtual resource environment are part of a physical resource environment. In general, a physical resource environment may be defined by its specific physical resources, the manner in which the physical resources are connected, and/or the boundaries among the physical resources. As an example, in accordance with some implementations, a given physical resource environment may be a physical datacenter (a public, private or hybrid datacenter, for example) or a partition thereof.

One way to assign physical resources that support a given virtual resource environment may be to assign the physical resources as the application is deployed in each of its lifecycle stages. However, different application teams may be concurrently working on the application in connection with different lifecycle stages; and such an approach may ignore the effects that the physical resource boundaries have on each other. Examples described herein may allow a user, such as a resource administrator, to predefine different physical resource environments for different lifecycle stages of the application. Such an approach may provide the advantage of taking into account or predicting the interdependencies of the physical resource environments, so that these interdependencies may be addressed. More specifically, in accordance with example implementations that are disclosed herein, the resource administrator may use a Devops resource policy engine to search for and identify one or multiple candidate physical resource environments for a given lifecycle stage so that one of these physical resource environments may be selected and used to support the virtual resource environment. This may allow the resource administrator to define the boundaries and resources of the physical resources for each application team, while considering the effects that a given physical resource environment may have on one or multiple other physical resource environments and/or considering how one or multiple physical resource environments may affect the given physical resource environment.

Configuring, controlling, and isolating the physical resource environment usage based on application lifecycle stage via the pre-designation discussed herein may enhance testing, resource requirement support, and the like. For example, the physical resource environments may be configured to isolate the physical resource environment used to run performance tests in the staging lifecycle stage from the other physical resource environments. The isolated environment may enhance the performance tests, as the isolated environment may isolate resource consumption by developers and testers in the development and testing lifecycle stages from affecting the performance test results in the staging lifecycle stage. As another example, the production stage may benefit greatly from being physically isolated from other environments so that the application may not exhibit a slow down because of resource consumption by the developers and testers. Moreover, the configuration, control and isolation of the physical resource environments may be beneficial for purposes of supporting different resource requirements. For example, physical resource environments that support the staging and production lifecycle stages may use SSDs for non-volatile memory, whereas physical resource environments that support development and testing lifecycle stages may use magnetic-based storage devices.

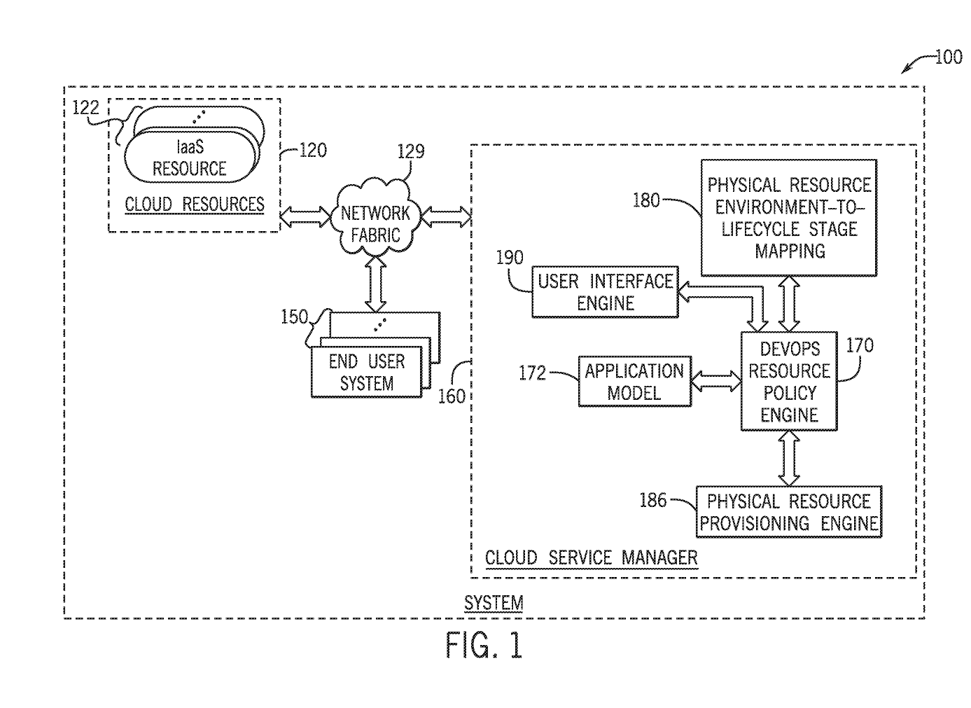

Referring to FIG. 1, as a more specific example, in accordance with some implementations, a networked computer system 100 may be used to deploy an application on different virtual resource environments for different lifecycle stages of an application. For this example implementation, the virtual resource environments may be provided by cloud resources 120. In particular, in accordance with example implementations, the cloud resources 120 may include the components of one or multiple Infrastructure as a Service (IaaS) services 122, which provide configurable virtual resource environments. As a more specific example, the IaaS service 122 may provide interfaces to allow configuration of virtual resource environments (in terms of the number of virtual machines, resource pool shares and so forth) and further allow configuration to partition and isolate physical resources based on a data center and/or resource pools. The virtual resource environment may be non-cloud based, in accordance with further example implementations.

For the example implementation of FIG. 1, an enterprise may use a cloud service manager, such as cloud service manager 160, for purposes of controlling the underlying physical resource environments onto which an application is deployed based on the lifecycle stage for the deployment. More specifically, in accordance with example implementations, the cloud service manager 160 of FIG. 1 includes a Devops resource policy engine 170 that may allow a user, such as a resource administrator, to set up different physical resource environments and associate (tag, for example) these environments with different lifecycle stages of an application. These associations may form a physical resource environment-to-lifecycle stage mapping 180, which the Devops resource policy engine 170 may access (search, for example) when the application is being deployed for a given lifecycle stage to a given virtual resource environment for purposes of selecting one or multiple underlying physical resource environments. A user may also use the Devops resource engine 170 to select/confirm the selected physical resource environment(s). A physical resource provisioning engine 186 may then communicate with the IaaS service 120 to provision the physical resource environment.

In accordance with example implementations, the Devops resource policy engine 170 may use information contained in an application model 172. The application model 172, in general, may define the layers of the application along with a “recipe” for managing the deployment of the application. Although a single application model 172 is depicted in FIG. 1, a given application may have several application models 172 such as, for example, for the scenario in which the application may be deployed on different operating systems or middleware containers.

Users (such as a resource coordinator) may access the user interface engine 190 of the Devops resource policy engine 170 using an end user system 150 (a desktop, portable computer, smartphone, tablet, and so forth) for such purposes as interacting with Devops components associated with the cloud service, including the Devops resource policy engine; submitting application deployment requests that are handled by the Devops resource policy engine 170 as well as potentially one or multiple Devops components or engines; creating descriptions of the physical resource environments; interacting with the Devops resource policy engine 170 to tag the physical resource environments with lifecycle stages to update, create or change the mapping 180; confirming a physical resource environment selected by the Devops resource policy engine 170 based on the mapping 180; receiving an indication of one or multiple candidate physical resource environment candidates for a given lifecycle stage from the Devops resource policy engine 170; selecting one of multiple candidate physical resource candidates presented by the Devops resource policy engine 170; and so forth. The cloud service manager 160 may contain Devops products or engines other than the engine 170, which may perform other functions related to the development and/or deployment of the application onto the cloud, in accordance with further implementations.

As depicted in FIG. 1, the end user systems 150, cloud service manager 160 and cloud resources 120 may communicate over network fabric 129 (network fabric formed from one or more Local Area Network (LAN) fabric, Wide Network (WAN) fabric, Internet fabric, and so forth).

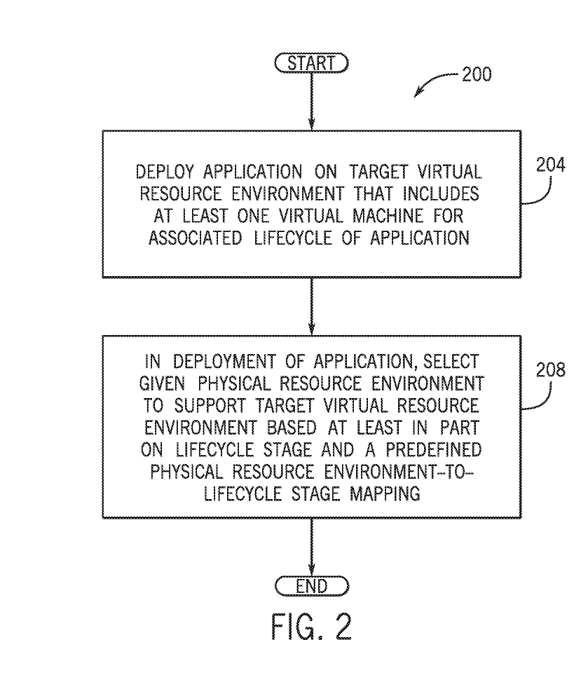

Referring to FIG. 2, to summarize, in accordance with example of implementations, a technique 200 may include deploying (block 204) an application on a target virtual resource environment, which includes at least one virtual machine, for an associated lifecycle of the application. The technique 200 may include, in the deployment of the application, selecting (block 208) a given physical resource environment to support the target virtual resource environment based at least in part on the lifecycle stage and a predefined physical resource environment-to-lifecycle stage mapping.

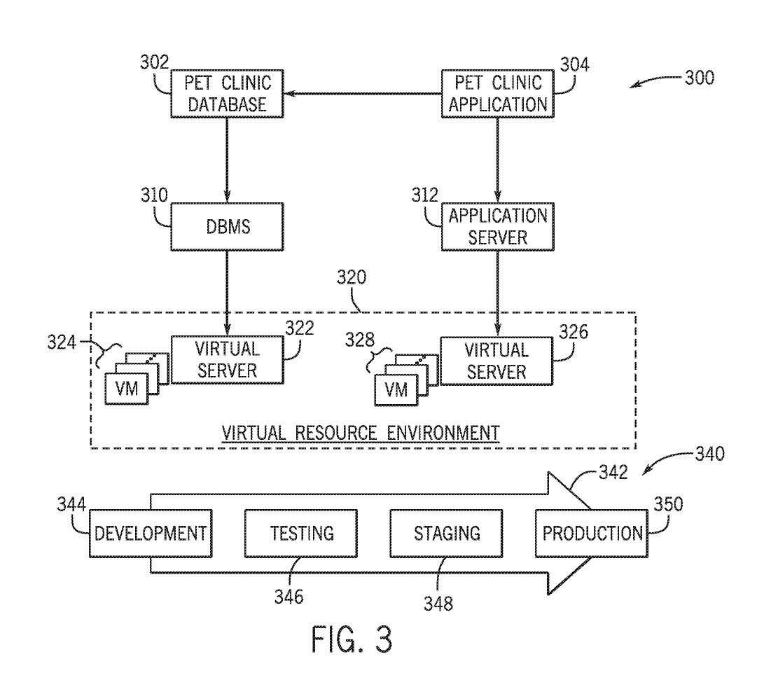

FIG. 3 is an illustration 300 of information conveyed by a two-tier application model (i.e., an example of model 172 of FIG. 1), in accordance with an example implementation. For this example implementation, a pet clinic application 304 is deployed on an application server 312. As an example, the application server 312 may be a web server, although other application servers may be used, in accordance with further example of implementations. The application server 312 for this example may be hosted on a virtual server 326 or virtual machine monitor. As illustrated in FIG. 3, the virtual server 326 may be part of a virtual resource environment 320, and the server 326 may have a set of associated virtual machines 328.

The example application model of FIG. 3 may also include a database configuration component in which a pet clinic database 302 may be used by the pet clinic application 304 and may be deployed on a DataBase Management System (DBMS) 310 that, in turn, may be hosted on a virtual server 322 that may be part of the virtual resource environment 320. As depicted in FIG. 3, virtual server 322 may have a set of associated virtual machines 324.

The application model 300 may further define the parameters (number of virtual machines 324 and 328, resource pools and so forth) for the virtual resource environment 320 based on the particular lifecycle stage involved with the deployment. As illustrated at 340, the model 300 may define parameter sets 344, 346, 348 and 360 that define the parameters of the virtual resource environment 320 for the development, testing, staging stage and production lifecycle stages, respectively

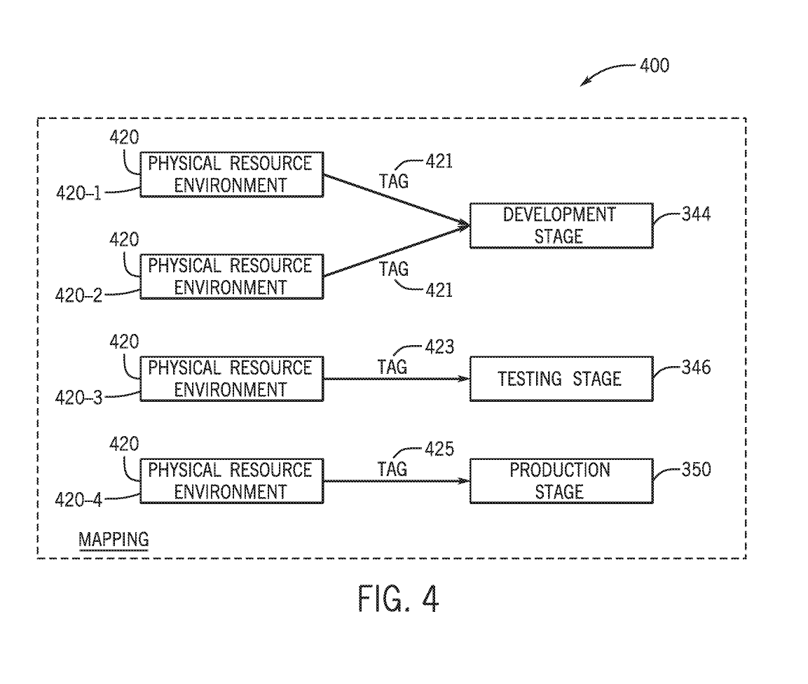

FIG. 4 depicts an example physical resource environment-to-lifecycle stage mapping 400 (i.e., an example of the mapping 180 of FIG. 1). Four physical resource environments 420 (physical resource environments 420-1, 420-2, 420-3, and 420-4) for this example are associated through tagging with three example lifecycle stages: a development lifecycle stage 344, a testing lifecycle stage 346, and a production lifecycle stage 350. More specifically, the physical resource environments 420-1 and 420-2 may be associated via a tag 421 with the development stage 324; the physical resource environment 420-3 may be associated via a tag 423 with the testing stage 346; and the physical resource environment 420-4 may be associated via a tag 425 with the production stage 350. This example tagging causes, when the application is deployed in the development stage 344, the application to either be deployed on a virtual resource environment supported by the physical resource environment 420-1 or on a virtual resource environment supported by the physical resource environment 420-2. Deployment of the testing 346 and production 350 stages, however, as illustrated in FIG. 4, may be assigned to specific physical resource environments 420-3 and 420-4, respectively.

As a more specific use example, example physical resource environments may be formed by partitioning a private cloud datacenter. For this example, the datacenter may have a total capacity of 800 GB RAM and ten Logical Units (LUNs) of two TeraBytes (TB) each. Out of the ten LUNs, two of the LUNs may support Solid State Drives (SSDs), while the other eight LUNs may be magnetic-based hard disk drives. As an example, a resource administrator may partition the datacenter resources to form four datacenter partitions: 1.) a first partition having 300 GB RAM and a three magnetic storage hard disk-based LUN; 2.) a second partition having 500 GB RAM and a five magnetic storage hard disk-based LUN; 3.) a third partition having 90 GB RAM and 1 SSD LUN: and 4.) a fourth partition having 110 GB RAM and one SSD LUN. For these four partitions of the datacenter, the resource administrator may create four different physical resource environments corresponding to the partitions and assign an associated lifecycle stage to each of these environments.

Referring back to FIG. 1, in accordance with some implementations, the physical resource environment-to-lifecycle stage mapping 180 may be stored in the form of a table. In this manner, in accordance with example implementations, the Devops resource policy engine 170 may search the table in response to the engine 170 receiving an application deployment request (a request initiated by a user using the user interface engine 190, for example). Table 1 below illustrates an example table for the mapping 400 of FIG. 4. In Table 1, the left column contains identifications (IDs) for the physical resource environments, and the right column contains identifiers for the lifecycle stages.

TABLE 1

| Environment ID | Lifecycle Stage Name |
|---|---|
| PhysicalResourceEnvironment_0001 | Development |
| PhysicalResourceEnvironment_0002 | Development |
| PhysicalResourceEnvironment_0003 | Testing |
| PhysicalResourceEnvironment_0004 | Production |

Thus, for example, in response to a deployment request for the development lifecycle stage, the Devops policy engine 170 may identify and select the physical resource environments that are associated with the Physical ResourceEnvironment_0001 and PhysicalResourceEnvironment_0002 IDs.

As illustrated in the example above, the mapping 180 (FIG. 1) may associate more than one candidate physical resource environment to a given lifecycle stage. Not all of the candidate physical resource environments that are selected via the mapping 180 may be appropriate for the target virtual resource environment due to, for example, capacities of the physical resource environments not meeting the minimum resource requirements that are imposed by the target virtual resource environment. In accordance with example implementations, the Devops resource policy engine 170 may filter the candidate physical resource environments selected via the mapping for purposes of removing any candidate environment that does not have a sufficient capacity to fulfill the deployment request. For example, a given application deployment may use a target virtual resource requirement that has a minimum memory capacity of 8 Gigabytes (GB) RAM and a minimum storage capacity of 500 GB. For this example, the Devops resource policy engine 170 may apply a filter to remove candidate physical resource environment(s) that each have a memory capacity below 8 GB and/or a storage capacity below 500 GB, so that the removed candidate physical resource environment may not be presented to the user.

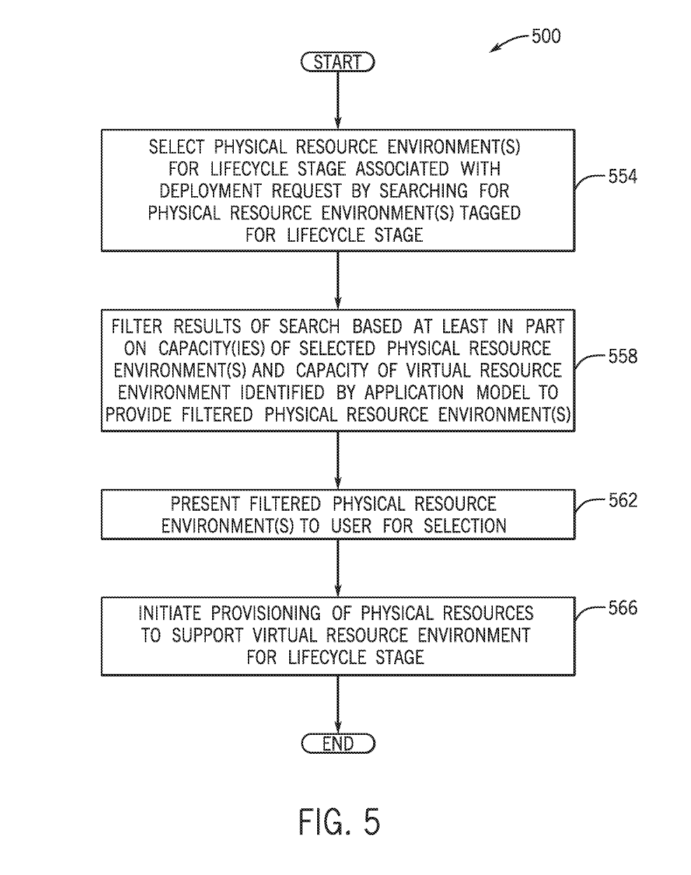

Thus, referring to FIG. 5 in conjunction with FIG. 1, in accordance with example of implementations, the Devops resource policy engine 170 may perform a technique 500 that includes selecting (block 554) one or multiple physical resource environments for a lifecycle stage that may be associated with a deployment request by searching for physical resource environments that are tagged for the lifecycle stage. Pursuant to block 554, the results of the search may be filtered based at least in part on the capacity(ies) of the selected physical resource environment(s) and the capacity(ies) of the virtual resource environment identified by the application model 170. The filtered physical resource environments may then be presented (block 562) to a user for selection; and upon the user making this selection, the provisioning of the physical resources to support the virtual resource environment may then be initiated, pursuant to block 566.

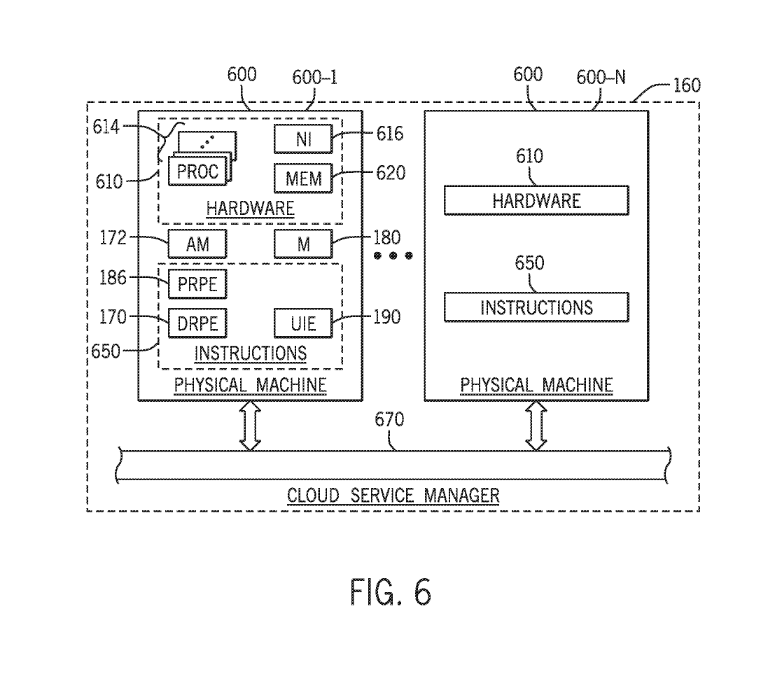

Referring to FIG. 6 in conjunction with FIG. 1, in accordance with example implementations, the cloud service manager 160 of FIG. 1 may include one or multiple physical machines 600 (N physical machines 600-1 . . . 600-N, being depicted as examples in FIG. 6). The physical machine 600 is an actual machine that is made of actual hardware 610 and actual machine executable instructions 650. Although the physical machines 600 are depicted in FIG. 6 as being contained within corresponding boxes, a particular physical machine 600 may be a distributed machine, which has multiple nodes that provide a distributed and parallel processing system.

In accordance with exemplary implementations, the physical machine 600 may be located within one cabinet (or rack); or alternatively, the physical machine 600 may be located in multiple cabinets (or racks).

A given physical machine 600 may include such hardware 610 as one or more processors 614 and a memory 620 that stores machine executable instructions 650, application data, configuration data and so forth. In general, the processor(s) 614 may be a processing core, a central processing unit (CPU), and so forth. Moreover, in general, the memory 620 is a non-transitory memory, which may include semiconductor storage devices, magnetic storage devices, optical storage devices, and so forth. In accordance with example implementations, the memory 620 may store data representing the application model 172 and data representing the mapping 180.

The physical machine 600 may include various other hardware components, such as a network interface 616 and one or more of the following: mass storage drives; a display, input devices, such as a mouse and a keyboard; removable media devices; and so forth.

The machine executable instructions 650 contained in the physical machine 600 may, when executed by the processor(s) 614, cause the processor(s) 614 to form one or more of the Devops resource policy engine 170, the physical resource provisioning engine 186 and the user interface engine 190. In accordance with further example implementations, one of more of the components 170, 186 and 190 may be constructed as a hardware component formed from dedicated hardware (one or more integrated circuits, for example). Thus, the components 170, 186 and 190 may take on one or many different forms and may be based on software and/or hardware, depending on the particular implementation.

In general, the physical machines 600 may communicate with each other over a communication link 670. This communication link 670, in turn, may be coupled to the user end devices 150 (see FIG. 1) and as such, may form at least part of the network fabric 129 (see FIG. 1). As non-limiting examples, the communication link 670 may represent one or multiple types of network fabric (i.e., wide area network (WAN) connections, local area network (LAN) connections, wireless connections, Internet connections, and so forth). Thus, the communication link 670 may represent one or more multiple buses or fast interconnects.

As an example, the cloud service manager 160 may be an application server farm, a cloud server farm, a storage server farm (or storage area network), a web server farm, a switch, a router farm, and so forth. Although two physical machines 600 (physical machines 600-1 and 600-N) are depicted in FIG. 6 for purposes of a non-limiting example, it is understood that the cloud service manager 160 may contain a single physical machine 600 or may contain more than two physical machines 600, depending on the particular implementation (i.e., “N” may be “1,” “2,” or a number greater than “2”).

While the present techniques have been described with respect to a number of embodiments, it will be appreciated that numerous modifications and variations may be applicable therefrom. It is intended that the appended claims cover all such modifications and variations as fall within the scope of the present techniques.

What is claimed is:

1. A method comprising:
deploying an application on a target virtual resource environment comprising at least one virtual machine for an associated lifecycle stage of the application;
wherein deploying the application comprises selecting a given physical resource environment to support the target virtual resource environment from a plurality of physical resource environments based at least in part on the lifecycle stage and a predefined physical resource environment-to-lifecycle stage mapping.

2. The method of claim 1, further comprising using an application model to define the target virtual resource environment.

3. The method of claim 1, wherein deploying the application further comprises deploying the application on a virtual server that manages the at least one virtual machine.

4. The method of claim 1, wherein selecting the given physical resource environment comprises determining a partition of physical resources of a datacenter, wherein the partition has an associated memory storage capacity and at least one associated data storage drive type.

5. The method of claim 1, wherein selecting the given physical resource environment comprises:
selecting multiple physical environments of the plurality of physical resource environments based at least in part on the lifecycle; and
filtering the selected multiple physical resource environments based at least in part on a minimum resource allocation associated with the application deployment.

6. An article comprising a non-transitory computer readable storage medium to store instructions that when executed by a processor-based machine causes the processor-based machine to:
receive a request to deploy an application on a target virtual environment for a lifecycle stage of the application out of a plurality of lifecycle stages of the application;
in response to the request, search for a group of physical resources tagged for supporting the target virtual environment for the lifecycle stage; and
initiate deployment of the application on the target virtual environment based at least in part on a result of the search.

7. The article of claim 6, wherein the search results in a plurality of groups of physical resources being identified having tags associating the groups with the target virtual environment.

8. The article of claim 7, the storage medium to store instructions that when executed by the processor-based machine cause the processor-based machine to:
filter the identified groups of filter resources based at least in part on a minimum resource allocation associated with the application deployment.

9. The article of claim 8, wherein the filter identifies a plurality of candidate groups of physical resources, and the storage medium to store instructions that when executed by the processor-based machine causes the processor-based machine to provide a user interface to allow a user to select one of the candidate groups.

10. The article of claim 6, wherein the instructions when executed by the processor-based machine causes the machine to search multiple groups of physical resources, the target virtual environment comprise one out of a plurality of virtual environments, each of the groups of physical resources being associated with a tag, and at least one of the tags identifying at least two of the groups of physical resources as supporting a given virtual environment of the plurality of virtual environments.

11. A system comprising:
a cloud service manager comprising a resource policy engine,
wherein the resource policy engine:
receives an indication from an application model identifying a target virtual resource environment onto which an application is to be deployed; and
selects at least one physical resource environment to support the target virtual resource environment from a plurality of physical resource environments based at least in part on a lifecycle stage of the application associated with the deployment.

12. The system of claim 11, wherein the cloud service manager comprises a user interface and the resource policy engine uses the user interface to present the at least one selected physical resource environment to a user.

13. The system of claim 11, wherein the resource policy engine selects multiple physical resource environments of the plurality of physical resource environments based on the lifecycle and filters the selected multiple physical resource environments based at least in part on a minimum resource allocation associated with the application deployment.

14. The system of claim 11, wherein the virtual resource environment comprises at least one virtual machine.

15. The system of claim 11, wherein the virtual resource environment is one of a plurality of virtual resource environments, the resource policy engine provides an interface to allow a user to associate tags with the physical resource environments, each tag identifying the associated physical resource environment as being predesignated to support at least one of the plurality of target virtual resource environments, and the resource policy engine searches the tags to select the at least one physical resource environment.
